(19) United States
(12) Patent Application Publication
(10) Pub. No.: US 2026/0257183 A1
(43) Pub. Date: Sep. 3, 2026

(54) POWDER DOSING METHOD

(71) Applicant: COMMISSARIAT A L'ENERGIE ATOMIQUE ET AUX ENERGIES ALTERNATIVES, Paris (FR)

(72) Inventors: Meryl BROTHIER, Aix-en-Provence (FR); Stéphane VAUDEZ, Avignon (FR)

(73) Assignee: COMMISSARIAT A L'ENERGIE ATOMIQUE ET AUX ENERGIES ALTERNATIVES, Paris (FR)

(21) Appl. No.: 18/881,920

(22) PCT Filed: Jul. 10, 2023
(86) PCT No.: PCT/FR2023/051067

§ 371 Date: Jan. 7, 2025

(30) Foreign Application Priority Data
Jul. 11, 2022 (FR) 2207101

(51) Int. Cl. B01F 35/75; B01F 23/50; B01F 23/80

(52) U.S. Cl. CPC B01F 35/751; B01F 23/56; B01F 23/806

(57) ABSTRACT

A method for dosing non-flowable powders. The method comprises the following: a) adding a cryogenic fluid, the powders to be dosed, and carbon dioxide in solid form, the mean particle diameter of which is between 0.1 and 10 times that of the powders; b) mixing and suspending the powders with the cryogenic fluid and the carbon dioxide in solid form to obtain a cryogenic suspension, the density percentage of the powders corresponding to 10%<[powders]vol<80%; c) removing the cryogenic suspension; d) controlling the dosage of the powders according to one or more parameters linked to the step of mixing and suspending the powders b); and e) dosing the powders.

### TECHNICAL FIELD

The invention relates to the field of the dosing of powders, and specifically of non-flowable powders which can be of any known type, particularly of high density and/or cohesive.

It applies to any industrial method using powders, particularly non-flowable powders. It relates to a method for dosing non-flowable powders and an associated device.

### PRIOR ART

Conventionally, different ways make it possible to carry out the function of powder dosing which are described hereinafter according to four concepts.

Firstly, cup dosing systems are composed of cups or dosing forms such as rotary flaps, powder sluices, inter alia. This type of solution is for example described in the article entitled “Manutention mécanique continue de produit en vrac”, Claude SAUDEMONT, Techniques de l′ingénieur, Reference AG7511 v1, 10 Jul. 2002. These systems also have several drawbacks. They can induce dosing dependent on the granular state of the powders to be dosed, in particular the degree of agglomeration, apparent density, inter alia. Furthermore, they induce jerky dosing.

Moreover, screw dosing systems are composed of worm screws or also so-called Archimedean screws which on account of their rotary movement make it possible to push a volume of granular medium between each turn. These systems have nonetheless several drawbacks. On one hand, they are only operative for powders of minimal flowability. On the other, they induce a modification of the granular medium on account of the impacts at pipe bends. Furthermore, they can induce a risk of clogging and only allow jerky dosing, namely at each turn.

Furthermore, vibrating plane dosing systems are composed of spindles generally subjected to oscillating vibrating movements to extract the granular medium as continually as possible. This type of solution is for example described in the thesis “Modélisation du comportement dynamique d′un plancher vibrant: interaction avec le milieu granulaire”, Benoît GELY, Sigma Clermont Auvergne University thesis, September 2017. These systems also have several drawbacks. They can induce segregation and are sensitive to the granular medium.

Finally, transported or fluidised bed dosing systems are systems wherein the powder to be dosed is subjected to a gas flow making it possible to form a gas suspension with the granular medium which is then extracted. These systems also have drawbacks. Indeed, they can result in non-operational dosing for a non-fluidisable medium and can also induce powder segregation. “Fluidisable” means that a powder belongs to group A or B of GELDART's classification as for example described in the article “Caractérisation et analyse des poudres-Propriétés physiques des solides divisés”, K. Saleh, P. Guigon, Techniques de l'ingénieur, 10 Mar. 2009.

Thus, the four types of solutions to the problem of powder dosing are not fully satisfactory, or not at all satisfactory for dosing non-flowable powders.

In particular, when using powders that flow with difficulty, or are even non-flowable, most of the dosing devices known from the prior art, particularly sluices, cups, worm screws, induce “stepwise” material distribution curves. These distributions are discontinuous and proceed in jerks. For a certain number of applications, such as dosing active ingredient in medicinal products, dosing sensitive reagents such as explosives, inter alia, discontinuous dosing is not acceptable, in particular on account of the existence of too many impacts in the heterogeneity of the material concentrations in the products to be prepared.

It is thus noted that there specifically remains a need to fulfil the function of dosing a non-flowable, or at least poorly flowable, granular medium, with in particular the following requirements: quick, continuous, precise in terms of dispensed flow rate, even with granular media considered non-flowable or fluidisable; with no risk of dispersion of constituent fine particles of the granular medium to be dosed; regardless of the pourability or the fluidisable nature of the powder to be dosed; without inducing segregation of the granular medium to be dosed; without compacting the granular medium.

Moreover, other cryogenic crushing methods and devices are known from French patent applications FR 3 072 307 A1 and FR 3 072 308 A1 for which the operating parameters are not satisfactory with regard to the stated needs.

### DISCLOSURE OF THE INVENTION

Hence, the aim of the invention is that of addressing at least partially the needs mentioned above and remedying the drawbacks relating to embodiments of the prior art.

Specifically, the aim of the invention is particularly that of being able to dose a granular medium as precisely as if it were a fluid but without inducing liquid effluent to be treated and without having subsequently to separate in a costly and/or lengthy way the powder from the carrier fluid which could be used for this. The aim is also that of being able to dose any type of powder, of a particle size that can range from a few nanometres to a few centimetres, and for variable densities without limitation, that can be very low-density or, on the other hand, very dense. Similarly, the aim of the invention is that of limiting any risk of introduction of impurities following the dosing and allowing an inerting of the granular medium.

In addition, the invention relates, according to one of its aspects, to a method for dosing non-flowable powders, characterised in that it includes the following steps:
a) adding a cryogenic fluid, powders to be dosed and carbon dioxide in solid form in a mixing and suspension system, the mean particle diameter of the carbon dioxide in solid form being between 0.1 et 10 times that of the particle size of the powders to be dosed,
b) mixing and suspending the powders with the cryogenic fluid and the carbon dioxide in solid form, to obtain a cryogenic suspension, the density percentage of the powders verifying the following equation (i):

$$10 \% < {[ powders ]}_{vol} < 80 \% , \qquad ( i )$$

where:
[powders] vol is the density percentage of the powders,
c) removing the cryogenic suspension, comprising the extraction of the cryogenic suspension, in particular under conditions of temperature greater than or equal to ambient temperature and pressure less than or equal to atmospheric pressure,
d) controlling the dosage of the powders according to one or more parameters linked with mixing and suspension step b),
e) dosing the powders.

The dosing method according to the invention is thus adapted to powders described as “non-flowable”. The concept of “flowability” corresponds to the property of a granular medium of flowing naturally. It can be characterised by several methods. One of these can be obtained from a Carr index type measurement. By definition, this index is determined as the ratio between the difference between the apparent volume occupied by a given quantity of powders and the settled volume of the same quantity of powders, the whole standardised on the apparent volume. Above a Carr index of 25, the granular medium is conventionally considered as very poorly flowable. Below a Carr index of 15, the granular medium is considered as relatively flowable. Thus, for the purposes of the invention, non-flowable powders refers to powders in which the Carr index is strictly greater than 15, and preferably greater than or equal to 25.

Furthermore, the concept of “mean diameter” of a granular medium is used insofar as the granular medium in question is not formed of solid particles all having the same size and not generally strictly spherical. The particle size is in this a distribution of size, surface area, or equivalent volume. With this static distribution, it is possible to associate a concept of mean size also referred to as “mean diameter”. Such a concept is for example described in the article “Caractérisation de la taille des particules”, John DODDS, Gérard BALUAIS, Sciences Géologiques, bulletins et mémoires, 46-1-4 pages 79-104, 1993.

The choice of the range of values of the mean particle diameter of carbon dioxide with respect to that of the particle size of the powders to be dosed is advantageous in that it results from accounting for a large number of factors and physical phenomena, concomitantly incorporating rheological, sedimentation stability and energy efficiency criteria.

In respect of the rheological aspect, it must be taken into account in particular in terms of viscosity and overall flow behaviour. In the case of viscosity, it is correlated with the particle size but also with the incorporation rate (quantity of solid material in a given volume of liquid). While there may be a link between particle size and viscosity, this link is not direct, however, when the suspended solids are not strictly monomodal (monomodal scenario only when the powders are so-called model powders, which is not the case in actual industrial use scenarios). However, the actual powders to be transported are not monomodal and solid carbon dioxide also may not have strictly the same particle size as the powder to be transported (in mean diameter and/or in particle size range). As such, it is important to be able to adjust the mean diameter of the carbon dioxide to obtain a suspension which has an acceptable viscosity to be circulated via a hydraulic system without expending too much energy for this purpose. This adjustment cannot be known in advance and must be adjusted on a case-by-case basis. Moreover, the incorporation rate, the polydispersity of the solids, or their morphologies, also play a role in the overall flow behaviour of the suspension. There is no direct correlation between all these parameters and the behaviour of the suspension which can be either Newtonian behaviour, or rheo-thickening, rheo-fluidising, or thixotropic. Ideally, a Newtonian behaviour will be sought but some systems can readily resemble them.

In respect of the sedimentation stability, the suspension behaviour in liquefied gas medium is not known to a person skilled in the art. Indeed, this type of suspension does not induce an electrical charge interaction between the liquid and the solid (the liquefied gas liquid being totally anionic and free from charge inversion layer as in conventional liquids). In the case of very fine solids (submicronic, or of a few hundred nanometres), atypical behaviours can be created (impact of Brownian motion for example). There may also be agglomeration of aggregates of solid material which then results in accelerated sedimentation of the solid phase. If the carbon dioxide used instead of being very fine is relatively coarse with respect to the transported powder, this can make it possible to avoid these phenomena but, on the other hand, the mixture will lose homogeneity, which is not favourable for the sought transport function. Note moreover that if the mean diameter of the solid carbon dioxide is too high, this phase will be impacted (for example mixing, high head losses induced, etc.) by the narrow passages of the hydraulic circuits for conveying the suspension.

To account for all these parameters and phenomena, the mean particle diameter of the carbon dioxide in solid form is between 0.1 and 10 times that of the particle size of the powders to be dosed. More preferably, to obtain a more optimised compromise in particular between rheology and settling stability, the mean diameter of the carbon dioxide in solid form can be between 1 and 8 times that of the particles size of the powders to be dosed, in particular between 2 and 6 times that of the particle size of the powders to be dosed.

Furthermore, the conditions of equation (i) given above advantageously make it possible to obtain a stable and pumpable cryogenic suspension. Also, advantageously, the cryogenic suspension is stable and pumpable thanks to the conditions established in the invention relating to the mean particle diameter of the carbon dioxide in solid form and the density percentage of the powders.

It should be noted that “stable” means that a suspension is considered as stable when the time required for full settling of the suspension is at least ten times greater than the time of the transport, or transfer, operation thereof. Typically, within the scope of the invention, the powder transport, or transfer, duration can be of the order of a few minutes whereas the stability duration can be of the order of one hour.

Advantageously, the presence of carbon dioxide in solid form in the cryogenic suspension can make it possible to act as a steric stabiliser of the powders in order to prevent their sedimentation.

It should be noted that “pumpable” means the capacity of a formulation to be used via a conventional pumping system, such as a piston pump or rotor. It should however be noted that a suspension characterised as “pumpable” is not necessarily intended to be pumped but is capable of being pumped if needed. This “pumpable” concept appears for example in the presentation entitled “Formulation, homogénéité et pompabilité”, François DE LARRARD, BétonlabPro 3, Lesson No. 13, Laboratoire Central des Ponts et Chaussées—Nantes Centre (LCPC). Intrinsically, a suspension is considered as “pumpable” insofar as the motive force accessible by conventional pumping systems (in particular piston or rotor pump) to allow its displacement in a given circuit is greater than the braking force induced by the viscosity of the suspension. Conventionally, a suspension having a viscosity of the order of 100,000 mPa·s is considered as non-pumpable. A suspension having a viscosity less than 20,000 mPa·s is considered as pumpable.

The method according to the invention can furthermore include one or several of the following features taken separately or according to any technically feasible combinations.

Advantageously, the cryogenic fluid is a liquefied gas at ambient temperature and pressure. It can particularly be liquid nitrogen (N₂). However, this choice is not limiting. The cryogenic fluid makes it possible to define the fluidic, in particularly liquid, behaviour of the cryogenic suspension and makes it possible, where applicable, to keep the carbon dioxide (CO₂) in solid form.

Moreover, solid carbon dioxide, also known as dry ice, can be presented in granule and/or powder form. This dry ice makes it possible, by its size or occupancy rate in the cryogenic suspension, to stabilise the powders to be dosed.

The first step a) can advantageously include the following successive sub-steps:
a1) adding the cryogenic fluid and carbon dioxide in solid form in the mixing and suspension system, then
a2) adding powders to be dosed in the mixing and suspension system.

Advantageously, adding the cryogenic fluid and carbon dioxide, preferably carried out simultaneously, precedes adding the powders to be dosed.

The duration between the two sub-steps a1) and a2) can be very short, in particular of the order of a few seconds, and thus the second sub-step a2) can be carried out almost immediately after the first sub-step a1).

Nevertheless, as a general rule, the duration between the two sub-steps a1) and a2) can depend on the time taken to obtain a homogenised and good-quality suspension between the cryogenic fluid and carbon dioxide. In particular, the second sub-step a2) can be implemented when the stirring torque of the mixing between the cryogenic fluid and carbon dioxide is substantially constant, in particular with a variability less than 10%, more preferably 5%.

Removing the cryogenic suspension corresponds advantageously to a displacement of the cryogenic suspension to allow its removal. It can thus comprise the extraction of the cryogenic suspension and also the volatilisation of the cryogenic suspension. Volatilisation can be induced by the temperature and pressure conditions set up during removal or be obtained via volatilisation means provided for this purpose.

Moreover, the load ratio of carbon dioxide in solid form can between 0.1 and 10 times that of the powders to be transported.

Step d) of controlling the dosing of the powders can allow the acquisition and processing of the measurement of the stirring torque of the cryogenic suspension, to allow one or more controlling actions on one or more controllable members.

Moreover, the invention furthermore relates, according to another of its aspects, to a device for dosing non-flowable powders for the implementation of the method for dosing non-flowable powders as defined above, characterised in that it includes:
a system for supplying powders, carbon dioxide in solid form and cryogenic fluid, including controlled adding means of the powders to be dosed and controlled adding means of carbon dioxide in solid form,
a system for mixing and suspending the powders, the carbon dioxide in solid form and the cryogenic fluid to obtain a cryogenic suspension,
a system for removing the cryogenic suspension, comprising a device for extracting the cryogenic suspension associated with a mass flowmeter,
a system for controlling the dosing of the powders.

The mixing and suspension system can furthermore comprise: a mixing tank; a mixing and stirring device, located inside the mixing tank; a means for measuring the level of the cryogenic suspension formed, at least in part located inside the mixing tank.

Moreover, the mixing and suspension tank can comprise an optical monitoring system for checking the concentration homogeneity in the cryogenic suspension.

### DESCRIPTION OF THE FIGURES

The invention may be better understood on reading the detailed description of non-limiting examples of implementation thereof and on examining the schematic and partial figures, wherein:

FIG. 1 represents a simplified logic diagram of the principle of dosing with a dosing device for the implementation of a dosing method according to the invention,

FIG. 2 schematically illustrates an example of a device for dosing non-flowable powders for the implementation of a dosing method according to the invention,

FIG. 3A is a schematic view along a sectional plane along the Z axis of FIG. 2 and FIG. 3B is a schematic left-hand section view of FIG. 3A, illustrating the cryogenic suspension volatilisation and evaporation principle,

FIG. 4A,

FIG. 4B

and FIG. 4C illustrate, according to sectional views, possible variants of mixing and stirring devices for the mixing and suspension system for a dosing device for the implementation of a dosing method according to the invention,

FIG. 5 graphically illustrates the course of the stirring torque of the cryogenic suspension according to the stirring time and three additions of solid load,

FIG. 6 represents the course of the viscosity according to the shear rate for alumina and dry ice suspensions in liquid nitrogen, and

FIG. 7 represents the course of the viscosity according to the shear rate for different dry ice suspension concentrations in liquid nitrogen.

In all of these figures, identical references can denote identical or equivalent elements.

Furthermore, the different parts represented in the figures are not necessarily represented according to a uniform scale, to render the figures more readable.

### DISCLOSURE OF EMBODIMENTS

The cryogenic fluid FC is here liquefied nitrogen (N₂) but this choice is not limiting.

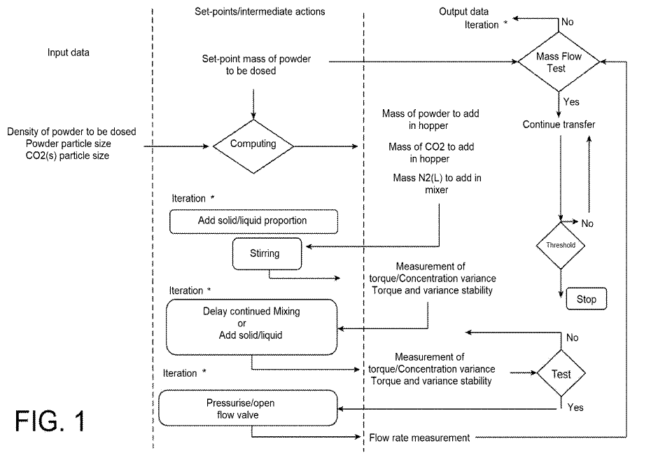

FIG. 1 is a simplified logic diagram of the control required for proper operation of the dosing to specify the sequence of measurements and input and output data required for controlling the dosing of a dosing device for the implementation of a dosing method according to the invention.

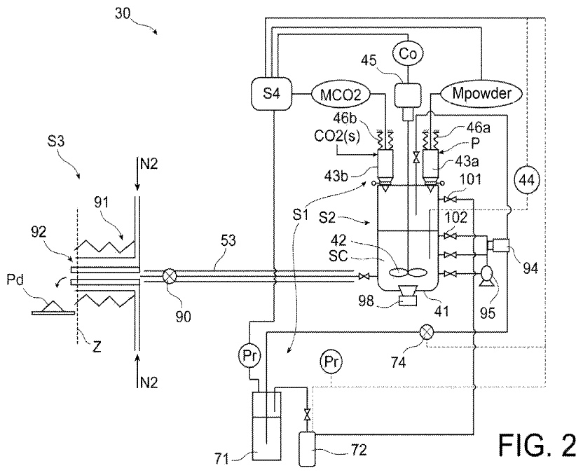

FIG. 2 represents an example of a device 30 for dosing non-flowable powder P for the implementation of a dosing method according to the invention. This includes firstly a system S1 for supplying powders P and cryogenic fluid FC, which includes controlled adding means 43a of the powders P to be dosed and, in this example controlled adding means 43b of carbon dioxide in solid form CO₂(s).

Furthermore, the device 30 includes a system S2 for mixing and suspending the powders P, the cryogenic fluid FC and the carbon dioxide in solid form CO₂(s) to obtain a cryogenic suspension SC. It also includes a system S3 for removing the cryogenic suspension SC, and finally a system S4 for controlling the dosing of the powders P.

Moreover, the system S3 for removing the cryogenic suspension SC comprises a device 91, 92 for extracting and, in this example volatilising the cryogenic suspension SC associated with a mass flowmeter 90. Alternatively, it must be possible to obtain volatilisation spontaneously without passing via dedicated volatilisation means by the temperature and pressure conditions applied. In particular, the temperature can be greater than or equal to ambient temperature and the pressure can be less than or equal to atmospheric pressure.

The control system S4 is configured to allow the acquisition and processing of the measurement of the stirring torque Co of the cryogenic suspension SC.

Such a device 30 makes it possible to implement the method according to the invention. Thus, a step a) allows the addition of the cryogenic fluid FC, powders P to be dosed and carbon dioxide in solid form CO₂(s) in the mixing and suspension system S2.

This step a) can be carried out with simultaneous addition of the ingredients. However, advantageously, step a) includes two successive sub-steps: a step a1) of adding the cryogenic fluid FC and carbon dioxide in solid form CO₂(s) into the mixing and suspension system S2, then a step a2) of adding powders P to be dosed into the mixing and suspension system S2.

Advantageously, the mean particle diameter of the carbon dioxide in solid form CO₂(s) is between 0.1 and 10 times that of the particle size of the powders P to be dosed, and the density percentage of the powders P verifying the following equation (i):

$$10 \% < {[ powders ]}_{vol} < 80 \% , \qquad ( i )$$

wherein [powders] vol is the density percentage of the powders P.

A step b) is then implemented of mixing and suspending the powders P with the cryogenic fluid FC and the carbon dioxide in solid form CO₂(s), followed by a step c) of removing the cryogenic suspension SC, comprising the extraction of the cryogenic suspension SC, in particular under conditions of temperature greater than or equal to ambient temperature and pressure less than or equal to atmospheric pressure.

A step d) makes it possible to control the dosage of the powders P according to one or more parameters Co linked with mixing and suspension step b), and a step e) doses the powders P.

The system S2 for mixing and suspending the powders P, the cryogenic fluid FC and the carbon dioxide in solid form CO₂(s) to obtain a cryogenic suspension SC can in particular include at least in part the elements of the devices described in French patent applications FR 3 042 985 A1 and FR 3 042 986 A1.

This system S2 comprises a mixing tank 41. The mixing tank 41 is lagged, thermally insulated, to make it possible to keep the liquefied gas in liquid nitrogen form without excessive volatilisation. Ideally, the heat losses would be of the order of 2% per day or less.

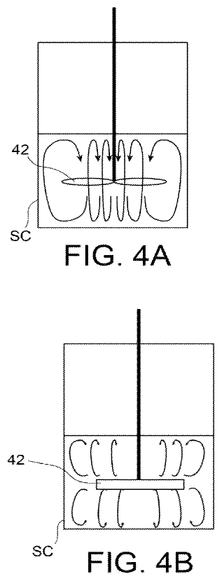

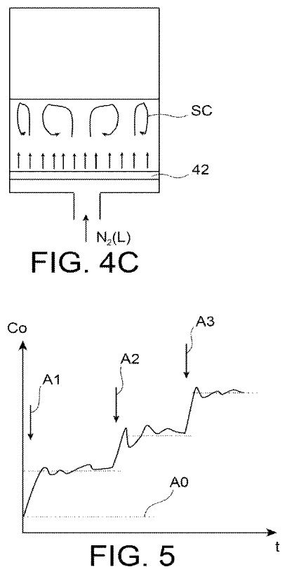

Also, the system S2 comprises a mixing and stirring device 42, located inside the mixing tank 41. This mixing and stirring device 42 can in particular be a stirring spindle, for example such as a blade, impeller, turbine, anchor, attritor or other, chosen in particular according to the viscosity of the cryogenic suspension SC envisaged. It can consist of any other profile optionally assisted by one or more acoustic stirring systems, such as ultrasound stirring rods for example. The mixing and stirring device 42 can for example be a blade type stirring spindle as shown in FIG. 4A, or a turbine type stirring rotor as shown in FIG. 4B, or a porous dispensing element with an injection of liquefied nitrogen N₂(I) as shown in FIG. 4C.

The mixing and stirring device 42 is rotated to generate the stirring via a drive motor 45. This motor 45 incorporates a means for measuring torque Co of the cryogenic suspension SC in order to identify whether the suspension is homogeneous, the torque Co then being substantially constant with a variability less than 10%, or 5%, and the adapted load ratio. This mixing and stirring device 42 can furthermore be supplemented by an ultrasound stirring system 98, for example a stirring sonotrode, to prevent any accumulation at the bottom of the tank 41, and/or using an upward flow of chemical inert gas, such as nitrogen, to promote stirring according to the granular medium to be dosed.

The controlled adding means 43a, 43b of the powders P to be dosed and the carbon dioxide in solid form CO₂(s) in the mixing tank 41 comprise particularly a first supply hopper 43a for adding the powders P to be dosed and a second supply hopper 43b for adding the carbon dioxide in solid form CO₂(s). Controlled adding is performed by weight of dosage. For this purpose, the supply hoppers 43a, 43b are used in connection with respectively weighing systems 46a, 46b corresponding to suspended balances or weight indicators. It is thus possible to monitor the mass added as a function of time.

Furthermore, the supply system S1 includes a first, heat-insulated, supply tank 71 of liquid nitrogen, and a second supply tank 72 of nitrogen in compressed gas form. Furthermore, a mass flowmeter 74 is present at the mixing tank 41, for example of Coriolis effect or ultrasound type.

It should be noted that, according to the specificity of the granular medium to be transported, namely the cryogenic suspension, in particular according to its particle size and its density, the proportions of powders P, optionally of carbon dioxide in solid form CO₂(s) and liquid nitrogen can vary. However, in order to obtain a cryogenic suspension SC which is stable and pumpable according to the definitions given above, the density percentage of the powders P verifies the following equation (i): (i): 10%< [powders]ᵥₒₗ<80%, wherein [powders] vol is the density percentage of the powders P.

In FIG. 2, the presence should furthermore be noted of a valve 101 for pressurisation and allowing the supply of gaseous nitrogen for pressurising the tank 41; and the presence of a three-way valve 102 allowing inline withdrawal for particle size diagnostics.

In the aim of obtaining a cryogenic suspension SC which is pumpable and stable in the sense of the invention, the major parameters to be determined and/or monitored are:
the load ratio of the powders P, namely the volume of solid over the total volume of the suspension SC: it will advantageously be sought to increase this ratio to the highest possible value to optimise the quantity of powders P does for a given volume of cryogenic suspension SC displaced;
optionally, the load ratio of the carbon dioxide in solid form CO₂(s): this ratio is conventionally dependent on the quantity of powders P to be added in the cryogenic suspension SC;
the density of the powders P to be dosed: as a general rule, the higher density and the larger the particle size of the powders P, the more it will be sought to form viscous suspensions incorporating large quantities of carbon dioxide CO₂(s) to limit the risks of settling of the powders P to be dosed in the cryogenic suspension SC;
optionally the particle size of the carbon dioxide in solid form CO₂(s), given in particular by the mean diameter of the particle size distribution of the carbon dioxide available to formulate the cryogenic suspension SC;
the particle size of the powders P given in particular by the mean diameter of the particle size distribution of the granular medium to be transported.

Also, advantageously:
the particle size of the carbon dioxide in solid form CO₂(s) is linked with that of the powders P to be dosed: the mean diameter being approximately between 0.1 and 10 times the particle size of the powders P to be dosed, or between 1 and 8 times, or between 2 and 6 times of the particle size of the powders P to be dosed;
the load ratio of carbon dioxide in solid form CO₂(s) is linked with that of the powders P to be dosed: more specifically, it is substantially of the same order of magnitude, the value being between approximately 0.1 and 10 times the content of powders to be dosed;
the liquid nitrogen content is limited as much as possible: it is advantageously less than 70% by volume; this liquid nitrogen content must nonetheless make it possible to render the suspension flowable and cannot be less than 5% by volume;
the particle size of the solid phase, comprising the powders P to be dosed and here the carbon dioxide in solid form CO₂(s), is less than 10 times the diameter of the transport pipe without which segregations could take place and cause loss of integrity of the granular medium to be dosed.

Advantageously, the particle size of the dry ice can be between 500 and 900 μm.

Regarding the suspension of powders P in the cryogenic fluid FC, it is necessary to control the homogeneity of distribution of the powders P as this corresponds to controlling the dosed mass. Indeed, the uncertainty of the dosed flow rate can be expressed as follows as a function of the uncertainty on the homogeneity, or more specifically on the variance with the equation (ii):

$$dM / M = dQ / Q + d V / V + d t / t , \qquad ( ii )$$

where:
M is the dosed mass,
Q is the mass flow rate,
V is the variance, and
t is the dosing time.

In order to ensure satisfactory homogeneity, i.e. a low variance V, or close to zero ideally, it is necessary to ensure a perfectly stirred reactor type stirring in the tank 41 for forming the cryogenic suspension. In other words, at each point of the volume of the tank 41, ideally, there is the same concentration of powders P. Thus, at the outlet of the tank 41, the concentration of powders P corresponds to the mean concentration in the tank 41 and the mass of powders P dosed is thus controlled by controlling the dosing time via this equation (ii).

Moreover, the system S2 comprises a means 44 for measuring the level of the cryogenic suspension SC formed, at least in part located inside the mixing tank 41. More particularly, this measuring means 44 can take the form of a bubbling tube or an ultrasound probe.

Advantageously, the system S2 also comprises an optical monitoring system 94 for checking the concentration homogeneity in the cryogenic suspension SC. This can correspond to a flowmeter coupled with a laser diode or a camera with image analysis for identifying the inline particle concentration homogeneity. It is associated with a peristaltic pump 95 allowing the circulation of the suspension towards the optical monitoring system 94.

Moreover, the removal system S3 comprises a lagged conduit 53 which allows transport of the formulated suspension while limiting heat losses to the point of arrival. The length of the lagged conduit 53 must be chosen such that the travel time must be substantially less than the stability time of the solution, in particular of the order of at least a factor of 10. The conduit 53 is associated with a mass flowmeter 90, of Coriolis effect or ultrasound type for example.

The extraction and volatilisation device 91, 92 of the removal system S3 also comprises an exchanger and evaporator device 92 which allows the exchange and evaporation of the liquefied nitrogen phase N₂(I). The cryogenic suspension SC is thus removed continually via the pressurisation in the preparation tank 41 to ensure easy and controlled extraction. It also includes a porous element, referred to as poral, 92 which corresponds to a tube for removing nitrogen vapour while allowing inerting or cladding of the opening to prevent the formation of ice plugs at the opening.

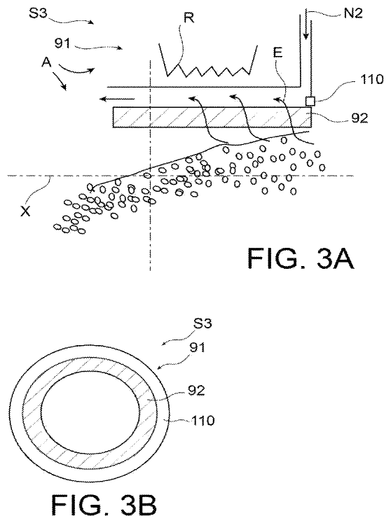

FIGS. 3A and 3B make it possible to illustrate the principle of volatilisation and evaporation of the cryogenic suspension SC. In these figures, the references Sp, A, X and Sp respectively represent the surface area of the cryogenic suspension, the circulating air in the vicinity, the axis of symmetry and a heating resistance. Furthermore, a seal 110 is provided.

To stabilise the cryogenic suspension SC, it is also possible to electrostatically charge the powders P to be dosed. To do this, the powders P can be previously subjected to a substantial difference in electrical potential or can be charged by friction induced in a receptacle the oscillation of which will create wall frictions against powders charging the latter according to the nature of the wall of the receptacle used.

Furthermore, to ensure good stirring by mechanical effect, it is necessary to rotate the stirring spindle 42 such that it makes it possible not to leave powders in contact with the wall of the bottom of the tank 41. The minimum rotational speed of the spindle 42 must at least induce turbulence in which the speed is greater than the separation velocity. “Separation velocity” means a velocity of the liquid phase of a suspension for which the separation phenomenon occurs. To summarise, the separation phenomenon is a phenomenon which is applied to a laminar boundary layer and which is often the source of the turbulence because it produces potentially unstable zones. During separation, the point of zero velocity which was initially adhered to the wall is found in volume: this is separation, and a new return boundary layer appears on the wall. It is recommended by Mersmann, in the article “Theoretical prediction of the minimum stirrer speed in mechanically agitated suspensions”, Mersmann A., Werner F., Maurer S., Bartosch K., Chem. Eng. Process., vol. 37, pp. 503-510, 1998, to impose a rotational speed (Nₘᵢₙ) of the stirring spindle 42 at least equal to a value that can be expressed by the following relation:

$${N}_{min} = 5 , 1 {N}_{p}^{- 7 / 18} \cdot {( \frac{{D}_{T}}{D} )}^{3 / 2} \cdot {( \frac{{d}_{p} g \vert {ρ}_{S} - {ρ}_{L} \vert}{{D}^{2} {ρ}_{L}} )}^{1 / 2}$$

wherein:
Nₘᵢₙ is the minimum stirring speed;
Np is the power number (evaluable parameter according to the type of stirring spindle);
D_{T} is the diameter of the stirring spindle;
D is the diameter of the stirring tank;
dp is the powder particle diameter;
g is the unit of gravity;
ρₛ is the density of the powders; and
ρ_{L} is the density of the liquefied gas.

To ensure good stirring by fluidisation, the liquefied gas phase must have a sufficient surface velocity, compared to that of the powders P, which is dependent on the particle size of the granular medium to be fluidised and in particular on the physicochemical properties of the liquefied gas. More specifically again, the minimum surface velocity to be ensured must have the minimum fluidisation value u_{mF}. This velocity is expressed thanks to the following equation linking the Reynolds number with that of Archimedes:

$${Re}_{mF} = \sqrt{{C}_{1}^{2} + {C}_{2} \cdot Ar} - {C}_{1}$$

where

$${Re}_{mF} = \frac{{ρ}_{f} \cdot {u}_{mF} \cdot {d}_{p}}{μ} and Ar = \frac{{d}_{p}^{3} \cdot g \cdot {ρ}_{f} \cdot ( {ρ}_{s} - {ρ}_{f} )}{{μ}^{2}} \vert$$

where:

$${C}_{1} = 3 \cdot ( 1 - {ε}_{mF} ) \cdot \frac{{h}_{K}}{{h}_{B}} and {C}_{2} = \frac{{ε}_{mF}^{3}}{6 \cdot {h}_{B}}$$

ε_{mF} is the porosity of the bed of powders to be fluidised; and
hk and hB are coefficients corresponding to the configuration of the system to be considered.

Thus, for example, for a powder bed that can be considered as spherical: ε_{mF}≈0.4, where hK≈4.2 and hB>0.3, this gives C1≈25 and C2≈0.04.

Furthermore, the suspension can be stabilised using solid carbon dioxide CO₂(s) or by applying electrostatic charges. The powders P are then charged by charge carriers of the same sign and the liquefied gas being neutral, the powder grains on moving closer together naturally by sedimentation will repel each other due to electrostatic repulsion and therefore retain a state of equilibrium at the dispersion.

In addition, the electrostatic charging of the powders P can be performed by triboelectricity or discharge charging. Regarding electrostatic charging by tribology, the powders are placed in a container, the nature of which is chosen such that an electron transfer can be performed between the powders P and the walls of the container coming into contact with the latter. Transfer is possible and more or less easy according to the charge potential of each of the materials in friction against each other.

Moreover, the system S4 for controlling the removal of the cryogenic suspension SC allows in particular the removal of the cryogenic suspension SC according to at least one parameter linked with the mixing and suspension system S2, in particular the torque Co. The control system S4 makes it possible to compile all the measurements made on the device 30 for dosing the powders P, and allows the control actions or feedback on controllable members, such as valves, pump, stirring motor, etc.

Thus, the controlling system S4 integrates the acquisition and processing of several data items:
the measurement of the quantity of materials of the dry ice MCO2 and the powders Mpowder, as well as the cryogenic fluid FC, so as to evaluate the volume and/or mass contents of the ingredients of the cryogenic suspension SC;
the measurement of the level of the mixing tank 41 to prevent its clogging and evaluate the density of the cryogenic suspension SC formed;
the measurement of the stirring torque Co for evaluating the viscosity of the cryogenic suspension SC and for checking that it is homogeneous and sufficiently stirred;
the optical measurement of the solid concentration in the tank 41;
the pressure measurement to set the flow rate of motion of the suspension measured by mass flowmeter.

Furthermore, in order to produce a homogeneous suspension and allow precise dosing of the powders to be dispensed, it is possible to distinguish three possible strategies.

Firstly, the dilute suspension preparation. This is the preferred case for powders of small particle size and low density. The volume concentration threshold of powders to be dosed in the cryogenic fluid FC can be within the interval [0; 10%] for this type of suspension. The stabilisation of the suspension by electrostatic charge can be envisaged for these cases of dilute solution.

Secondly, the dense suspension preparation. This is the case to be preferred for powders with a larger particle size and higher density. The volume concentration threshold of powders to be dosed in the cryogenic fluid FC can be within the interval [20%; 80%] for this type of suspension. The stabilisation of the suspension by electrostatic stability becomes difficult from 20% of solid incorporation content in the suspension. To stabilise the suspension, from these thresholds (order of magnitude because dependent not only on the concentration but on the particle size and the density of the powders in particular), it can be envisaged to stabilise the suspensions by steric size and increase in viscosity of the suspension by adding solid carbon dioxide CO₂(s).

Thirdly, the intermediate-density suspension preparation. The volume concentration of powders to be dosed in the cryogenic fluid FC can be within the interval [10%; 20%] for this type of suspension. In this scenario, a combination of mechanical and/or ultrasound and/or convective flow stirring means is to be envisaged.

It should be noted that the stirring speed must make it possible to attain a sufficient level of turbulence. Note that when the particles are separated from the bottom of the tank 41, it is sought to prevent the stagnation of particles at the tank bottom and with an even higher level of turbulence, it is sought to obtain a homogeneous distribution of the particles in the volume of the suspension. The present invention makes it possible to obtain this homogeneity of particle distribution in the suspension.

In addition, for a complete suspension, namely when no particle remains at the bottom of the stirred tank 41, all the particles must be separated and redeposition must be rendered impossible.

However, to obtain a homogeneous suspension, it is necessary to push the stirring speed but in the knowledge that the ideal homogeneity of the solid phase disposed in the suspension forms an asymptote. Note that in practice, a suspension with an Archimedes number greater than 10 cannot attain complete homogeneity.

Generally, there is a compromise between homogeneity and energy to be introduced into the suspension in the form of turbulence. The optimal stirring speed corresponding to this compromise is the order of 1.8 to 2 times the value of the minimum stirring speed.

All of these instructions should make it possible to optimise the homogeneity of the powders P for a given and optimised cryogenic suspension volume, while guaranteeing the possibility of implementing the suspension by pressurisation. This results in a limited viscosity, of the order of 100,000 mPa·s, and the formulation of a suspension adapted to the removal pipe at the doser.

Regarding the stirring torque parameter Co, FIG. 5 graphically represents the value of the stirring torque Co as a function of time t. The references A0, A1, A2 and A3 correspond respectively to the off-load torque, to a first addition of solid load, to a second addition of solid load and to a third addition of solid load. Thus, at each addition of material A1, A2 and A3, the torque Co increases for a given stirring speed. However, after a certain stirring duration, the torque Co tends to stabilise as shown by the plateaus in FIG. 5. This then makes it possible to optionally add an additional quantity of powders P in the cryogenic suspension SC if the transport flow rate set-point requires it, for example.

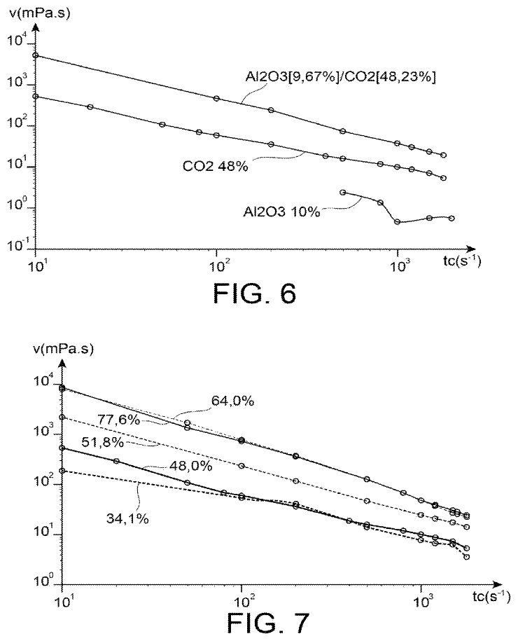

Via FIGS. 6 and 7, a rheological behaviour of several cryogenic suspensions SC that can be envisaged within the scope of the invention is described.

Specifically, FIG. 6 represents the course of the viscosity v, expressed in mPa·s, according to the shear rate tc, expressed in s⁻¹, for suspensions of alumina (Al₂O₃), dry ice in liquid nitrogen.

FIG. 6 illustrates the rheological behaviour of three systems: Al₂O₃/CO₂: suspension of liquid nitrogen containing almost 10% (by volume) of Al₂O₃ and 48% (by volume) of solid CO₂; CO₂: suspension of liquid nitrogen containing 48% solid CO₂; and Al₂O₃: suspension of liquid nitrogen containing 10% Al₂O₃.

This experimental curve makes it possible to indicate that the viscosities of the suspensions in question exhibit manageable rheological properties in terms of circulation and stirring, that is to say the viscosity is not too high to be pumpable or it is possible to stir without excessive energy expenditure. Moreover, these experimental elements acquired by the inventors show that the behaviours of the suspensions in question are comparable in the experimental range in question to Newtonian fluids.

Moreover, FIG. 7 represents the course of the viscosity v, expressed in mPa·s, according to the shear rate tc, expressed in s-1, for different concentrations of dry ice suspensions in liquid nitrogen.

Specifically, FIG. 7 illustrates the rheological behaviour of five systems: 34%: suspension of liquid nitrogen containing almost 34% (by mass) of solid CO₂; 48%: suspension of liquid nitrogen containing almost 48% (by mass) of solid CO₂; 51.8%: suspension of liquid nitrogen containing almost 51.8% (by mass) of solid CO₂; 64%: suspension of liquid nitrogen containing almost 64% (by mass) of solid CO₂; 77.6%: suspension of liquid nitrogen containing almost 77.6% (by mass) of solid CO₂.

This experimental curve makes it possible to indicate that the viscosities of the suspensions in question exhibit manageable rheological properties in terms of circulation and stirring, that is to say the viscosity is not too high to be pumpable or it is possible to stir without excessive energy expenditure. This aspect is not trivial in the light in particular of the substantial proportion of constituent solid of these suspensions. Moreover, these experimental elements acquired by the inventors show that the behaviours of the suspensions in question are comparable in the experimental range in question to Newtonian fluids, which allows control and more consolidated mastery of the method.

Hence, FIGS. 6 and 7 make it possible to illustrate the viscosities of the cryogenic suspensions and show the influence of the dry ice content on the viscosity of the fluid to be transferred.

Generally, the rheological behaviour of the cryogenic suspensions SC can be approximated by semi-empirical laws. For example, an expression of the suspension viscosity according to the load ratio and the particle size of the constituent solid of this suspension can be given hereinafter by the equation (ii):

$$μ / μ 0 = ( 1 + 1 / 2 \cdot [ N ] \cdot ϕ / {( 1 - ϕ / {ϕ}_{m} )}^{2} , \qquad ( ii )$$

where:
μ is the viscosity of the suspension;
μ₀ is the viscosity of the liquid phase;
[N] is a constant;
φ is the volume of solid in the volume of the suspension;
φₘ is the maximum volume of solid in the volume of the suspension.

In the knowledge of the viscosity of the suspensions, it is then possible to infer therefrom the possible dispensing flow rate Qv of the according to the overpressure to be applied in the tank to ensure a flow rate according to the powder dosing set-point. The equation (iii) given hereinafter can thus be obtained:

$$Δ P = ( 8 \cdot μ \cdot L ) \cdot Qv / ( π \cdot {R}^{4} ) , \qquad ( iii )$$

where:
ΔP is the difference in pressure between upstream and downstream from the flowmeter;
μ is the viscosity of the suspension;
Qv is the volume flow rate;
R is the radius of the fluid transport conduit;
L is the length of the transport conduit.

The invention is obviously not limited to the embodiment examples described above. Various modifications can be made by a person skilled in the art.

1. A method for dosing non-flowable powders, the method comprising:
a) adding a cryogenic fluid, powders to be dosed, and carbon dioxide in solid form in a mixing and suspension system, the mean particle diameter of the carbon dioxide in solid form being between 0.1 and 10 times that of the particle size of the powders to be dosed;
b) mixing and suspending the powders with the cryogenic fluid and the carbon dioxide in solid form to obtain a cryogenic suspension, the density percentage of the powders satisfying the following equation (i):
$$10 \% < {[ powders ]}_{vol} < 80 \% , \qquad ( i )$$
where [powders]ᵥₒₗ is the density percentage of the powders;
c) removing the cryogenic suspension, comprising extracting the cryogenic suspension under conditions of temperature greater than or equal to ambient temperature and pressure less than or equal to atmospheric pressure;
d) controlling a dosage of the powders according to one or more parameters linked with the mixing and suspension step b); and
e) dosing the powders.

2. The method according to claim 1, wherein the adding a) comprises:
a1) adding the cryogenic fluid and carbon dioxide in solid form in the mixing and suspension system; and
a2) adding the powders to be dosed in the mixing and suspension system.

3. The method according to claim 1, wherein the mean particle diameter of the carbon dioxide in solid form is between 1 and 8 times the mean particle diameter of the powders to be dosed.

4. The method according to claim 1, wherein a load ratio of carbon dioxide in solid form is between 0.1 and 10 times that of the powders to be dosed.

5. The method according to claim 1, wherein step d) of controlling the dosing of the powders comprises acquiring and processing of a measurement of a stirring torque of the cryogenic suspension, to allow one or more controlling actions on one or more controllable members.

6. The method according to claim 1, wherein the cryogenic fluid is liquid nitrogen.

7. The method according to claim 1, wherein the carbon dioxide in solid form is in the form of granules and/or powders.

8. A device suitable for dosing non-flowable powders according to the method of claim 1, the device comprising:
a system (S1) suitable for supplying powders, carbon dioxide in solid form, and cryogenic fluid, the system (S1) comprising controlled adding means of the powders to be dosed and controlled adding means of carbon dioxide in solid form;
a system (S2) suitable for mixing and suspending the powders, the carbon dioxide in solid form, and the cryogenic fluid to obtain a cryogenic suspension;
a system (S3) suitable for removing the cryogenic suspension, the system (S3) comprising a device suitable for extracting the cryogenic suspension associated with a mass flowmeter, the extraction device suitable for extracting being configured to extract a cryogenic solution under conditions of temperature greater than or equal to ambient temperature and pressure less than or equal to atmospheric pressure; and
a system (S4) suitable for controlling the dosing of the powders, configured to control the system (S1) for supplying powders, carbon dioxide in solid form, and cryogenic fluid such that the density percentage [powders]ᵥₒₗ of the powders satisfies the following equation (i):
$$10 \% < {[ powders ]}_{vol} < 80 \% , \qquad ( i )$$
and configured to control the dosing of the powders according to one or more parameters linked with the mixing and suspending step b).

9. The device according to claim 8, wherein the system (S2) suitable for mixing and suspending the powders comprises:
a mixing tank;
a mixing and stirring device, located inside the mixing tank; and
a means for measuring the level of the cryogenic suspension formed, at least in part located inside the mixing tank.

10. The device according to claim 8, wherein the system (S2) suitable for mixing and suspending the powders comprises an optical monitoring system for checking the concentration homogeneity in the cryogenic suspension.
